(19) United States
(12) Patent Application Publication
(10) Pub. No.: US 2011/0315931 A1
(43) Pub. Date: Dec. 29, 2011

(54) NANOPARTICLE CATALYSTS AND METHOD OF USING THE SAME FOR BIOMASS GASIFICATION

(75) Inventors: Allen A. Aradi, Glen Allen, VA (US); Joseph W. Roos, Mechanicsville, VA (US); Tze-Chi Jao, Glen Allen, VA (US)

(73) Assignee: Afton Chemical Corporation, Richmond, VA (US)

(21) Appl. No.: 13/193,698

(22) Filed: Jul. 29, 2011

Related U.S. Application Data
(63) Continuation-in-part of application No. 12/685,791, filed on Jan. 12, 2010.
Application No. 12/685,791 is a continuation-in-part of application No. 12/475,664, filed on Jun. 1, 2009.

(51) Int. Cl. C01B 3/40; B01J 23/755; B01J 21/08; B01J 35/02; B01J 23/83; B82Y 30/00

(52) U.S. Cl. 252/373; 502/300; 502/304; 502/331; 502/337; 502/240; 977/902

(57) ABSTRACT

A nanoalloy catalyst, dual catalyst and methods for improving the efficiency and output of a biomass gasification process are provided where the catalysts comprise a volatile organometallic compound(s) and/or a nanoalloy catalyst. The subject nanoalloy catalyst cracks and gasifies lignin, which is generally inert in conventional gasification, at relatively low gasification temperatures. The subject disclosure also provides a means to increase gas yields and lower lignin content in the resulting product relative to conventional gasification. Alternatively, oil production may be increased, if desired. Moreover, the resulting gas may achieve a Fischer-Tropsch reactor favorable H₂:CO ratio of up to about 9:1. The energy input to the gasification is correspondingly reduced to reduce costs and the environmental impact associated with the gasification process.

### CROSS-REFERENCE TO RELATED APPLICATIONS

This application is a continuation in part of United States Patent Application Serial No. 12/685,791, filed Jan. 12, 2010, which is a continuation in part of United States Patent Application Serial No. 12/475,664, filed Jun. 1, 2009. The contents of each of these applications are incorporated by referenced herein in their entirety.

### FIELD OF THE DISCLOSURE

The present invention relates to a nanoalloy catalyst bonded to the surface of a support particle and/or method of using the same for improving the efficiency and output of a biomass pyrolysis and/or gasification process.

### BACKGROUND

Gasification is a process for converting carbonaceous materials into carbon monoxide and hydrogen by reacting the raw material at high temperatures with a limited but measured amount of oxygen and/or steam. The idea is to extract energy from different types of organic materials. If the biomass is naturally sufficiently oxygenated, then no oxygen and/or steam need be utilized in the gasification.

Biomass is an abundant and renewable resource, and the gasification process produces fuels and compositions that can be used in many industries. For instance, the resulting mixture of carbon monoxide and hydrogen gas that results from biomass gasification is known as synthesis gas or syngas. The syngas product can be a more efficient combustion source than the original biomass material. The syngas can be used as a synthetic fuel for transportation, electrical production, or other industries. As another example, the chemical industry could employ gasification products such as olefins (e.g., propylene, ethylene, and the like) and aldehydes, such as formaldehyde, for polymeric materials.

The amount of energy introduced to the gasification process is a major expense that subtracts from the net power production from the syngas. There is also an environmental impact to producing the required energy for gasification. Biomass gasification with optimization of syngas yield is an ongoing challenge that, if overcome, could enable efficient conversion of biomass carbon to syngas. Biomass gasification and combustion, overall, is a renewable energy that is potentially CO₂-neutral. That is, biomass cultivation can remove the same amount of CO₂ from the atmosphere as is emitted from gasification and combustion.

There is a need for improvements to the chemical biomass pyrolysis and/or gasification process. Ideally, such improvements would improve bio-oil or gas yield (whichever is the desired end product) and reduce lignin content in the resulting product, and otherwise produce an improved pyrolysis and/or gasification process for biomass. As much hydrogen should be stripped off the biomass to give H₂, and as much carbon converted to CO, as possible. With an H₂:CO mole ratio of 2:1 or greater, the syngas can comprise a feed stream into a Fischer-Tropsch reactor system for conversion to syncrudes that are either predominantly hydrocarbon or mixed alcohols based. Again, an advantage of fuels derived from biomass gasification is that they are carbon neutral and, therefore, are not a net contributor of CO₂.

### SUMMARY OF THE DISCLOSURE

The nanoalloy catalyst, optionally with a volatile organometallic compound as a dual catalyst, and methods of using the same of the present disclosure provide for improved pyrolysis and/or gasification of biomass including higher gas yields, reduced solid yields (including reduced tar and lignin), and reduced liquid yields.

In another embodiment, a composition comprises a nanoalloy catalyst and volatile organometallic compound alone. As also disclosed herein, there is provided a composition comprising a biomass and a nanoalloy catalyst, also referred to sometimes herein as “nanocatalyst”. The nanocatalyst is, in one embodiment, contacted with the biomass as a nanoalloy powder. In another embodiment, the nanocatalyst is an alcohol-dispersible nanoalloy.

The support material of the nanoalloy catalyst particle may comprise, but is not limited to, silica, alumina, titania, nanocarbon, graphene, activated carbon, thoria, zirconia, zeolites, mixtures thereof, and the like. The catalyst metal or metals of the nanoalloy may independently be, but are not limited to, Fe, Co, Ni, Mo, W, Th, Ru, Pt, Rh, Mn, Cr, Ga, La, Ce, Re, Pd, Ti, or K. In at least one embodiment, the support material is about 50 wt% of the overall nanocatalyst particle.

In another embodiment, the nanoalloy catalyst may be represented by the formula SAxByCz where ‘S’ is a support as disclosed above and ‘A’ is a metal-containing compound. ‘B’ represents a promoter, which may comprise one or more metals. ‘C’ is an activator, such as Pt, Pd, Rh, Ru, Os, Ir, Zr, La, Ce, Li, K, and Na. ‘A’ could in one example be 25 to 80 wt%, ‘B’ could in one example be 15 to 25 wt%, and ‘C’ could in one example be .001 to 1 wt%. The nanoalloy might comprise multiple metal-containing compounds (e.g., S(A₁)(A₂) . . . ByCz) as might the promoter and activator. In another example, the overall wt% ratio of nanoalloy catalyst particle lies within the range of 25 to 80 wt% for metal-containing compounds, 15 to 25 wt% for any promoter and 0.001 to 1 wt% for any activator.

One method of pyrolyzing and/or gasifying a biomass comprises contacting a volatile organometallic compound with the biomass. In this embodiment, a second nanocatalyst as a dual catalyst is contacted with the biomass either before, with, or after the volatile organometallic compound. One or both steps of contacting the biomass with a catalyst from the dual catalyst can be optionally followed by the step of stripping a solvent(s) off the biomass under vacuum and/or warming conditions. The steps of contacting the biomass with the volatile organometallic and nanocatalyst can occur before and/or during the gasification of the biomass.

Biomass includes lignin structure. For example, plant-based biomass comprises about 15-25 wt% lignin, 23-32 wt% hemicelluloses, and 38-50% cellulose. The lignin matrix is the most difficult component to gasify. While a volatile organometallic compound for use in the dual catalyst cleaves the methoxy substituents of the lignin (see, copending U.S. Patent Application Serial No. 12/475,664), the lignin matrix in the biomass remains largely in tact. The remaining lignin comprises part of the char and part of the oil/liquid product following gasification.

In one embodiment, the dual catalyst as disclosed herein cracks the normally inert/non-reactive lignin matrix and gasifies it during the gasification process. By ‘cracks’, ‘cracking’, or ‘cracked’, it is meant herein that a lignin component is broken into smaller molecular weight components. Lignin is a relatively high molecular weight polymer. Cracking the lignin promotes, allows for, and/or facilitates gasification (e.g., increased bio-oil or syngas production at lower gasification temperatures).

If the nanocatalyst is a nanoalloy powder (i.e., not dispersed or suspended in an alcohol or other polar solvent), then product selectivity from the biomass gasification with a volatile organometallic compound significantly shifts from gases to bio-oils. Yet, unexpectedly, the nanoparticle-based catalyst prepared with a support, such as silica, as a dispersion in a polar solvent, such as but not limited to water, alcohols, including ethanol, and mixtures thereof, using a dispersant, switched the product selectively back to gases with the very high conversion efficiency of at least about 80% or in another embodiment at least about 85% at just 600° C. (following contacting the biomass with the volatile organometallic). Lignin levels were reduced from an average of about 25% by weight for the volatile organometallic alone to 4.39% by weight following the contacting of the biomass with the dual catalysts and gasification of a biomass at 600° C. In one gasification procedure, the volatile organometallic was present at 0.25 wt% to 8 wt% of the biomass. In one embodiment, the volatile organometallic was present at 1 wt% of the biomass. The nanoalloy catalyst can be present alone or with the volatile organometallic compound at 0.25 wt% to 5 wt% of the biomass. In one embodiment, the nanoalloy portion of the dual catalyst is present at 4 wt% as a wt percentage of the biomass. The nanocatalyst can be dispersed in ethanol using ethylene glycol. However, other dispersants, surfactants, alcohols, or polar solvents would be suitable.

An organometallic compound(s) of the subject dual catalyst and methods is oil-soluble or dispersed or mixed in a lubricant, carrier fluid, or fuel. The compound could be in liquid or solid states. The subject organometallic compounds can be contacted with the biomass before and/or during the gasification process. The organometallic compound can in one embodiment volatilize and thereby be injected into the gasification reactor or product (e.g., syngas) stream leaving the reactor. In one embodiment, the biomass is treated with a dilute solution of the volatile organometallic in a low boiling solvent. The solvent is then optionally stripped under appropriate conditions before or after contacting the biomass with the nanocatalyst.

By “organometallic compounds” herein is meant any molecules containing a carbon-metal moiety. These compounds may be “volatile” in that they can sublime or vaporize from ambient conditions up to about 450° C. Therefore, volatile organometallics could be, for example and without limitation, cyclomatic manganese carbonyl compounds such as methyl cyclopentadienyl manganese tricarbonyl (MMT), cyclopentadienyl manganese tricarbonyl, manganese carbonyl materials; ferrocene and iron carbonyl materials; cerium-containing compounds; platinum group metal compounds; and the like or mixtures thereof.

By “biomass” herein is meant wild, anthropogenically cultivated, genetically engineered, and/or bioengineered trees, bushes, grasses, algae, plankton, aquatic plants, yard trimmings and waste, wood chips, saw dust, mariculture products, animal parts and carcasses, animal waste, farm waste, agricultural waste, fodder, silage, organic waste and/or by-products and mixtures thereof alone or in combination with emulsions, suspensions, and dispersions thereof in water, alcohol, or other carrier fluids. ‘Biomass’ is broadly intended to mean woods, grasses, aquatic life, and/or animals or animal by-products/waste. In yet a further embodiment, “biomass” comprises coal, coal dust, and the like. In at least one embodiment, biomass is any renewable organic fuel source.

By “contacting” herein is meant the contacting, bringing together, reacting, complexing, coordinating, combining, admixing, mixing, and the like association between two or more materials, whether or not a chemical or physical reaction or change occurs.

For clarity, it should be understood that a ‘nanoalloy’ is different than a mixture or doped composition. In a mixture, the different elements in the mixture retain their chemical and physical characteristics, and their composite spectrum (i.e., XRD) is simply a superimposition of the spectra of the component elements in the mixture. A doped composition comprises small quantities of one element that are added to the bulk of another element with the intention of modifying the electronic properties of the bulk element through alteration of the crystal lattice of that element. To achieve the desired goal in electronics, the dopant is not homogeneously dispersed in the bulk material, but rather, interspersed in discrete islands in the bulk of the primary (major) element. The XRD spectrum resembles that of mixtures.

Nanoalloys comprise component elements that are homogeneously dispersed in each other to give a material similar to a liquid solution. A crystal lattice is formed to make up the nanoparticle. The spectrum (i.e. XRD) shows bands different from those one would observe by simply mixing the component elements together or doping one element with another, as described above. Therefore, a nanoalloy is basically a new composition of matter on the atomic scale. In other words, it is a hybrid product of the constituent elements and its reactivity is modified by the resultant rehybridized highest occupied molecular orbital (HOMO) and lowest unoccupied molecular orbital (LUMO) orbitals responsible for its chemical reactivity-selectivity. See, for instance, the article Synthesis and reduction behavior of sol-precipitated iron oxide/tungsten oxide nanoparticles, Journal of Alloys and Compounds 479 (2009) 613-618 (FIG. 2 illustrates a nano-mixture while FIG. 6 represents a nanoalloy).

The production of the nanoalloy may occur via a known process, such as the methods for making metal-containing nanoparticles as disclosed in U.S. Pat. Application No. 11/620,773, which is herein incorporated by reference in its entirety. Metal-containing nanoparticles or nanoalloy particles may have very small grain sizes of less than 50 nanometers. For example, the nanoparticles may have size or uniform size ranging from about 1 to about 30 nanometers. Other uniform particles sizes may range from about 2 to about 10 nanometers.

The gasification temperature may be any conventional temperature for gasifying a biomass. In one preferred embodiment, the gasification is conducted at a temperature from about 300° C. to 800° C. The increased yields achieved herein are achieved at the same or lower gasification temperatures than conventionally used. At or above 800° C. gasification is largely achieved due to the high energy input. In examples herein, one goal for biomass gasification has been to achieve higher gas conversion for biomass at temperatures less than 800° C.

In yet another embodiment of the disclosure, a method produces syngas from biomass gasification where the syngas has a H₂:CO mole ratio of at least 2:1. In one embodiment, the ratio is about 9:1. In another example, the ratio is from about 2:1 to 10:1. The method comprises contacting a biomass with at least a nanoalloy catalyst or a nanoalloy catalyst and an organometallic compound as disclosed herein before or during gasification. The resulting gas with a H₂:CO mole ratio of at least 2:1 may be further processed. In addition, the high level of hydrogen produced can facilitate installation of a hydrogenation reactor in series and downstream of the pyrolysis and/or gasification system disclosed herein. The hydrogenation reactor would passivate the oil product against reactions that contribute to viscosity increase during storage. That is, at least a portion of the hydrogen from the gasification conducted in the pyrolysis and/or gasification system can be used in the hydrogenation reactor to stabilize the oil product. Externally sourced hydrogen could be reduced or eliminated. As also noted below, stabilized bio-oil produced by the subject gasification and/or pyrolysis can be a raw material feed stock for existing refineries (i.e., refineries originally built for petroleum crude oils).

As noted above, the catalysts and methods disclosed herein provide improved gasification yields at gasification process temperatures lower than previously attainable. As such, there is an overall reduction in energy input while providing the increased gas yields. The reduction in energy reduces the cost and environmental impact associated with the gasification process. Conventionally, higher gasification reaction temperatures are employed in order to achieve higher gas yields. However, increased energy input is very expensive and incurs a corresponding, negative environmental impact (i.e., more fuel consumed to produce higher input temperatures). The subject method surprisingly provides increased gas and/or oil yields at reduced reaction temperatures.

The present disclosure further relates to a method for improving liquid yields. From the subject nanoalloy catalyst, dual catalyst and related methods, the resulting liquids, due to the production of methanol, are more stable than liquids/oils produced by biomass gasification without the addition of the subject organometallic compounds. It is also thought that the possible use of alkaline earth metals in the nanoalloy will provide a higher pH to the resulting oil. The higher pH maintains a low viscosity (i.e., renders the oil more stable) for later processing, if desired. As briefly noted above, the nanoalloy catalyst as a powder can increase oil yield whereas the nanoalloy catalyst dispersed in alcohol increases gas yields.

It is to be understood that both the foregoing general description and the following detailed description are exemplary and explanatory only and are intended to provide further explanation of the present invention, as claimed. The foregoing and additional features and advantages of the present invention will become apparent to those of skill in the art from the following detailed description taken in conjunction with the accompanying drawings.

### BRIEF DESCRIPTION OF THE FIGURES

FIG. 1 is a scanning electron micrograph (SEM) image of Example Catalyst BGC-2.

FIG. 2 is a TEM image of Example Catalyst BGC-2.

FIG. 3 is a TEM image of Example Catalyst BGC-2 that shows that the NiCu nanoalloy (about 10 nm in size) is a Ni-based nanoalloy containing around 68 wt% Ni and 32 wt% of Cu.

FIG. 4 is an SEM image of Example Catalyst BGC-3.

FIG. 5 is a TEM image of Example Catalyst BGC-3.

FIG. 6 is a TEM image of Example Catalyst BGC-3 showing that the NiCuCe nanoalloy (about 15 nm in size) is a Ni-based nanoalloy containing around 71.5 wt % Ni, 25 wt% Cu, and 3.5 wt% Ce.

### DETAILED DESCRIPTION OF THE DISCLOSURE

In further detail, the applied nanoalloy catalyst or dual catalyst and related methods provide improved biomass pyrolysis to produce more stable bio-oils and syngas. As noted above, the disclosure provides a means to increase gas or liquid yields, as desired, and reduce solid/char product. The term “gasification” here includes slow or fast pyrolysis/ gasification, in the absence or presence of oxygen, and/or in the absence or presence of steam, whereby the pyrolysis/gasification process is carried out sequentially, or simultaneously. The improved liquid and/or gas yields occur at lower biomass gasification temperatures than conventionally used.

The dual catalyst of one example herein comprises a volatile organometallic compound and a nanoalloy catalyst/nanocatalyst for improved gasification of biomass including higher gas yields, reduced solid yields, and reduced liquid yields. In another example, it is also possible to use the nanoalloy catalyst and/or dual catalyst disclosed herein for improved formation of bio-oils to produce higher oil yields where the oil is stable for additional processing.

The nanoalloy catalyst is a biomass pyrolysis catalyst that is made up of a support particle and metallic catalyst particles adhered to the surface of the support particle. The metallic catalyst particles comprise an alloy represented by the formula (Aa)ₙ (Bb)ₙ (Cc)ₙ, each of A, B, and C is a metal, each of a, b and c represents compositional stoichiometry, n is an integer greater than or equal to zero and the sum of the n′s is greater than or equal to 2. The nanoalloy catalyst includes at least two different metals. The two or more metals A, B and C are selected from the group consisting of Mn, Fe, Cu, Co, Ca, Rh, Pd, Pt, Ru, Ir, Ag, Au, Ce, Mg, Al, Si, Sc, Ti, Zn, Si, Y, Zr, Mo, In, Sn, Ba, La, Hf, Ta, W, Re, Yb and Lu. The metal A is the primary catalyst selected from the group consisting of Ni, Fe, Ce, Co, Mo, Mn, Ca, Mg and La. The metal B is a co-catalyst selected from the group consisting of Cu, Ce, Ni, Pt, Pd, Rh, Ru and Ir. The metal C is an anti-sintering metal or thermal spacer selected from the group consisting of Ce, K, Li, Zr, Hf, Mg and Ti.

The metallic catalyst component of the biomass pyrolysis catalyst makes up about 30% to 70% by weight of the biomass pyrolysis catalyst composition. In another example, the metallic catalyst comprises about 40% to 60% by weight of the biomass pyrolysis catalyst composition. In a further example, the metallic catalyst comprises about 45% to 55% by weight of the biomass pyrolysis catalyst composition.

The average particle size of the metallic catalyst particles that are bonded to the support particles is about 1 to 250 nanometers. In another example, the average particle size of the metallic catalyst particles is about 2 to 100 nanometers. In still further examples, the average particle size of the metallic catalyst particles is about 5 to 30 nanometers or 10 to 15 nanometers.

The average particle size of the support particles can be about 1000 μm to 10 nanometers. In other examples, the average size of the support particles is about 10 μm to 50 nanometers or about 1μm to 100 nanometers. The support particles are comprised of a material selected from the group consisting of silica, alumina, magnesia, thoria, zirconia, nanotubes, nanoballs, graphene, zeolite, and aerogel.

The metallic catalyst particles are adhered to the support particles. In other examples, the nanoalloy particles are physically adsorbed or chemically bonded onto the surface of the support particles or are trapped in porous cavities therein. Importantly, the metallic catalyst particles are adhered to the outside, exposed surfaces of the support particles to be best available for their catalytic purposes. There can be some adhering of the nanoalloy particles in porous cavities in support particles, but a substantial amount of the nanoalloy particles should be on a surface for most effective catalytic purposes.

It is believed that the hypothetical thermodynamics of the biomass pyrolysis catalyst or nanoalloy catalyst described herein is helpful in explaining the effectiveness of the present pyrolysis process. The pyrolysis process with respect to biomass is an exothermic process. If the nanoalloy catalyst metallic particles are too large, then the metal particle will retain excessive heat and reach high temperatures during the pyrolysis reaction process. This may result in sintering or vaporization of the alloy during the pyrolysis process. However, with the small nanoalloy particles described herein, and further with their adhering to the larger support particles described herein, it can be understood that the heat of reaction is dissipated across the entire catalyst particles described herein. This heat dissipation prevents the metallic particles from overheating.

One method of converting the biomass to oil and/or gas products comprises contacting the biomass with the nanoalloy catalyst. In another method, the biomass can also be contacted with the nanoalloy catalyst and volatile organometallic compound (nanoalloy catalyst and volatile organometallic compound as a dual catalyst). The nanoalloy catalyst of the dual catalyst is also contacted with the biomass before, during, or after the volatile organometallic compound. As disclosed below, the nanoalloy catalyst in powder form can significantly raise the liquid bio-oil yield relative to the solid and gas yields. Where the nanoalloy catalyst is dispersed by a solvent, surfactant, or combination of a solvent and surfactant, one or both steps of contacting the biomass with a catalyst from the dual catalyst can be followed by the step of stripping the solvent and/or surfactant used to disperse the catalysts off the biomass under vacuum and/or warming conditions.

In further detail, one method of the subject disclosure is a biomass pyrolysis and/or gasification process in a fluidized bed reactor using sand as the fluid and nitrogen as the fluidizer. The pyrolyis and gasification temperature conditions were 400 and 600° C., respectively. The dual catalyst comprised methylcyclopentadienyl manganese tricarbonyl as the volatile organometallic compound and an alcohol dispersible nanoalloy catalyst composition. The biomass was treated with a dilute solution of the volatile organometallic in a low boiling solvent, which was then stripped off under vacuum and warming conditions. The second dual catalyst component was simultaneously contacted with the biomass as a dilute dispersion or solution in ethanol (i.e., a low boiling point, polar solvent) using ethylene glycol as a dispersant. The solvent was also stripped off under appropriate conditions.

The dispersion of nanoalloy catalyst with a polar dispersant/surfactant is thought to be important for increasing gas yields from gasification as the biomass includes pores with polarity. The nanoalloy catalyst is dispersed or dissolved in a polar solvent (water, alcohol, etc or mixtures thereof) so as to better distribute the nanoalloy catalyst to the biomass surface. The polarity of the pores ‘draws’ the nanoalloy catalyst into the pores via the polar solvent/dispersant mix.

The nanoalloy catalyst or dual catalyst treated biomass is charged into the reactor in a conventional fashion. The biomass may be charged into the reactor after contacting the nanoalloy catalyst or dual catalyst or before. In other words, one or both catalysts may be applied before the biomass is charged into the reactor, after the biomass is charged into the reactor, or one catalyst before and one catalyst after. As noted above, the organometallic compound can in one embodiment volatilize and thereby be injected into the gasification reactor or product (e.g., syngas) stream leaving the reactor (which might be after contacting the biomass with the nanoalloy catalyst).

Surprisingly, the biomass treated in the manner(s) above has a very high gas selectivity with gas conversion efficiency of at least about 80% at just 600° C. and it is possible to obtain gas conversion efficiency at least as high as 85%. The high gas yield is at least partly a result of the reduction in lignin levels (i.e., lignin was cracked and gasified).

An organometallic compound(s) of the subject dual catalyst and methods can be oil-soluble or dispersed or mixed in a lubricant, carrier fluid, or fuel. The compound could be in liquid or solid states.

The pyrolysis and/or gasification temperature may be any conventional temperature for pyrolysis of a biomass, typically 800° C. and above. In one example, the pyrolysis is conducted at a temperature from 300° C. to 800° C. In another example, the reaction temperature is about 400° to 600° C.

Non-limiting examples and comparative data demonstrating utility of biomass pyrolysis catalyst composition

Catalysts were prepared as described in Table 1. Although only Ni, Cu, and Ce on SiO₂ are shown, other metals such as Fe, K, Mo, Mn, Ca, Mg, La, Li, Zr, Hf, Mg, and Ti can also be used. Other supports are Alumina, Titania, Thoria, Zirconia, Nanocarbon materials (nanotubes, nanoballs, and graphene) may be used. Also, Table 2 indicates that both powder and liquid forms of the catalysts were prepared.

TABLE 1
Catalyst formulation matrix

| | | | Co-catalyst | Thermal |
|---|---|---|---|---|
| Catalyst # | Support “S” | Catalyst “A” | “B” | Spacer “C” |
| BGC-2 | SiO₂ | Ni | Cu | |
| BGC-3 | SiO₂ | Ni | Cu | Ce |
| Proportion | 50% | 35% | 10% | 5% |
| Range | 40%-60% | 25%-45% | 5%-15% | 3%-6% |

TABLE 2
Some of the specific catalysts prepared

| Catalyst # | Code | State |
|---|---|---|
| 1 | BGC-2-1 | Powder |
| 2 | BGC-2-2 | Liquid |
| 3 | BGC-3-1 | Power |
| 4 | BGC-3-2 | Liquid |

Synthesis and Characterization of Biomass Gasification Catalysts Biomass catalyst BGC-2 SiO₂)50%Ni₄₀%Cu₁₀%

Support Preparation: MCM-41 SiO₂ was prepared from the basic hydrolysis of TEOS (Tetraethyl Orthosilicate). The procedure is as follows: 1.2 gm of CTAB (Cetyl Trimethyl Ammonium Bromide) was dissolved in 120 ml of water at room temperature. After complete dissolution, 8 ml of NH₃ (32% water) was added to the above solution. Then 10 ml of TEOS was added to the solution under vigorous stirring, and the reaction was left under stirring for 2 hours where the mesostructured hybrid material was formed. The material was then filtrated, and dried overnight in the oven at 80° C.

Catalyst preparation: A liquid sample was prepared by stirring the mixture of 2 gm of Si0₂+7.02 gm of Ni(NO₃)₂6H₂O +1.16 gm Cu(NO₃)₂6H₂O for 3 hours, water was removed by evaporation, dried in the oven overnight at 55° C. The product mixture was calcinated in H₂ atmosphere at 500° C. for 3 hours and then dispersed in 25 ml diethylene glycol and 75 ml ethanol. A solid-powder preparation was prepared by the same procedure except after calcination the sample was dispersed in ethanol and left to dry overnight.

Analysis of the product: XPS-data reveals that the Binding Energy of Ni (854.1 ev) and Cu (931.5 ev) on the surface are shifted either from elemental state (Ni=852.6 ev, Cu=932.7) or oxide (NiO =853.8 ev, Cu₂O=932.5 ev). This confirms that the Cu and Ni are in an alloy form at the surface of the support.

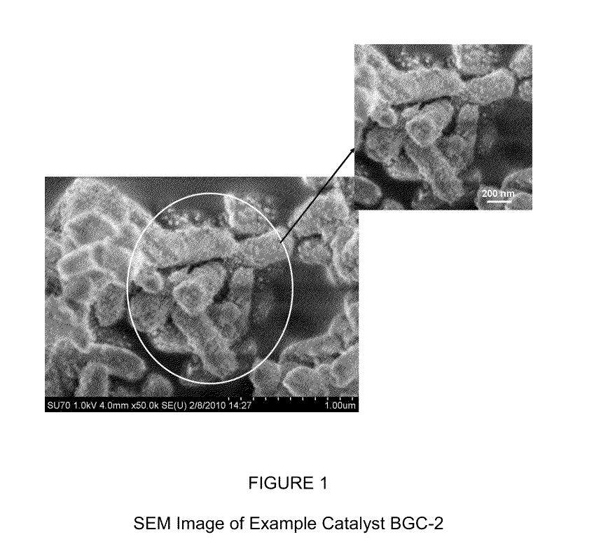

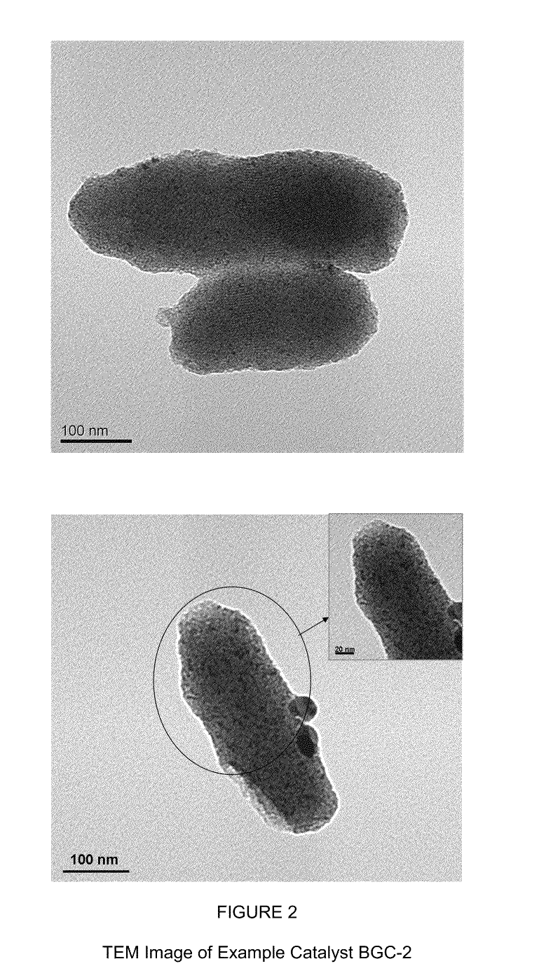

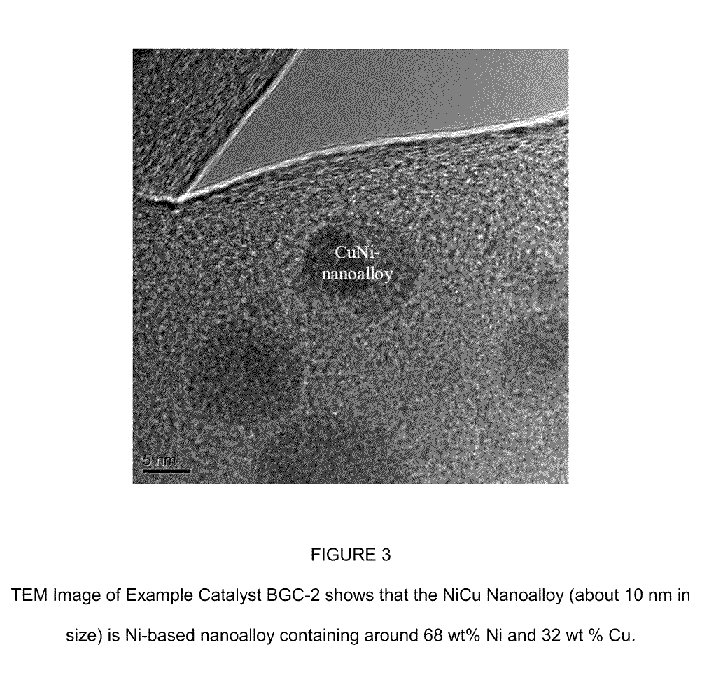

The biomass catalyst, BGC-2, has a calculated density of about 3.40 WI with NiCu particle size of about 10-15 nm as measured from an SEM image. See FIG. 1. SEM-EDX-analysis showed the chemical composition of the catalyst consisting of 48.5 wt% SiO₂, 37 wt% Ni, and 14.5 wt% Cu. FIGS. 2 and 3 are TEM-EDS images of the BGC-2 catalyst. The apparent size of the support particles shown in the figures is about 200 to 300 nanometers.

Biomass catalyst BGC-3 SiO₂)₅₀%Ni₃₅%Cu₁₀%Ce₅%

Support Preparation: MCM-41 SiO₂ was prepared from the basic hydrolysis of TEOS (Tetraethyl Orthosilicate). The procedure is as follows: 1.2 gm of CTAB (Cetyl Trimethyl Ammonium Bromide) was dissolved in 120 ml of water at room temperature. After complete dissolution, 8 ml of NH₃ (32% water) was to add to the above solution. Then 10 ml of TEOS was added to the solution under vigorous stirring, and the reaction was left under stirring for 2 hours where the mesostructured hybrid material was formed. The material was then filtrated, and dried overnight in the oven at 80° C.

Catalyst preparation: A liquid sample was prepared by stirring a mixture of 2 gm of SiO₂ +6.32 gm of Ni(NO₃)₂6.H₂O +1.01 gm Cu(NO₃)₂6H₂O +0.54 gm Ce(Ac)₃ for three hours, water was removed by evaporation, dried in the oven overnight at 55 ° C. The product mixture was calcinated in H₂ atmosphere at 500 ° C. for three hours and then dispersed in 25 ml diethylene glycol and 75 ml ethanol. A solid-powder preparation was prepared by the same procedure except after calcination the sample was dispersed in ethanol and left to dry overnight.

Analysis of the product: XPS-data reveals that the binding energy of Ni (854.1 ev) Cu (931.8 ev) and Ce (881.5) on the SiO₂ surface are shifted either from an elemental state (Ni=852.6 ev, Cu=932.7, and Ce=883.8) or oxide (NiO =853.8 ev, Cu₂O=932.5 ev and Ce0₂=882.1); this confirms that the Cu, Ni and Ce are in an alloy form at the surface of the support.

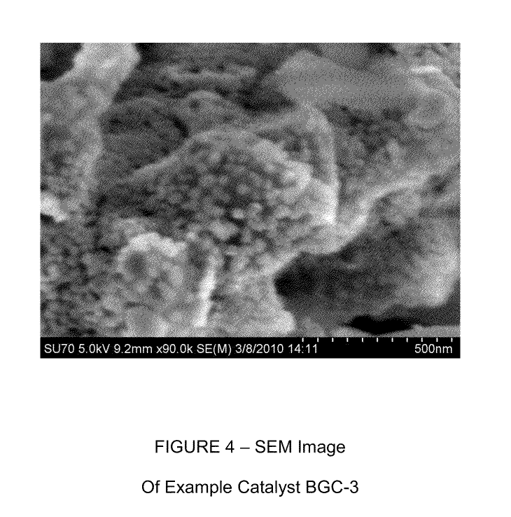

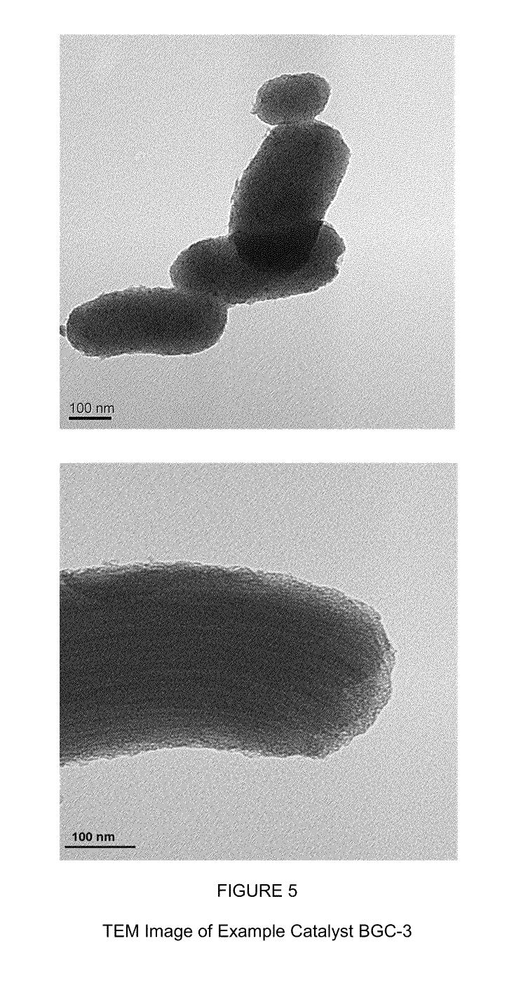

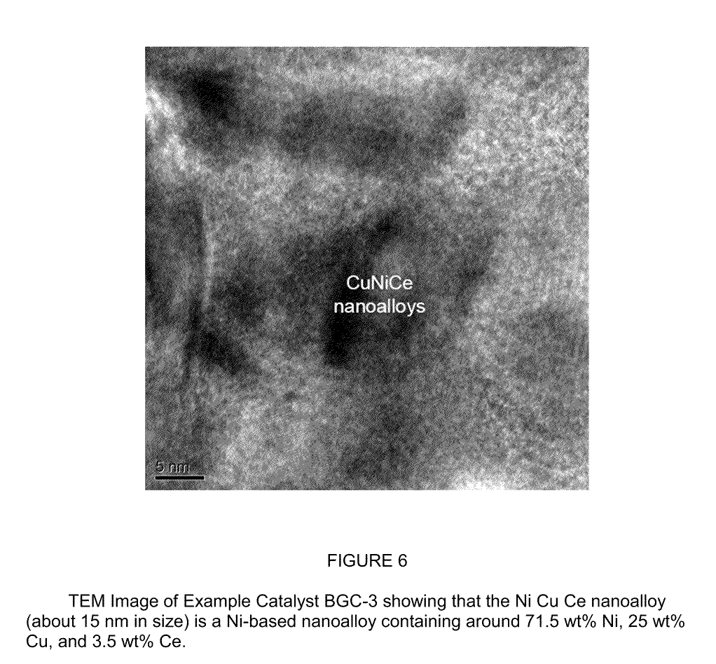

The biomass catalyst, BGC 3, has a calculated density of 3.41 WI with NiCuCe particle size of about 10-15 nm. SEM-EDX data shows the chemical composition of the biomass catalyst consisting of 49.5 wt% SiO₂, 34.5% Ni, 9.65 wt% Cu, and 6.35 wt% Ce. See FIG. 4. Also shown in FIGS. 5 and 6 are TEM-EDS images of the BGC-3 catalyst. The apparent size of the support particles shown in the figures is about 100 to 400 nanometers.

The foregoing catalysts were used in various pyrolysis tests to explore the effectiveness of the catalysts.

The biomass used was poplar and was ground in a Wiley mill to pass a 1 mm mesh screen. For the biomass feedstocks for the pyrolysis studies that were treated with liquid catalyst as described below: About 150 g of ground hybrid poplar wood was weighed into a glass beaker and 4 wt% (6 g) of liquid catalyst was weighed and added to 50 mL of reagent grade acetone. The acetone and liquid catalyst were well mixed and sprayed on the biomass. The biomass was thoroughly mixed with the acetone catalyst mixture until all the particles of biomass were wetted. The wetted biomass was left in the fumehood to dry overnight. The catalyst wood mixture was weighed again after drying before being loaded into the hopper.

The pyrolysis medium was silica sand fluidized with nitrogen gas. The biomass in every example feedstock was loaded into the K-Tron feeder and conveyed by a twin screw feeder into an entrainment zone. The feed was entrained with a nitrogen gas and conveyed through a cooling air-jacked tube into the fluidized bed pyrolysis reactor. The reactor temperature was maintained at either 400 ° c or 600 ° c for the pyrolysis. The pyrolysis vapors exited the top of the reactor and entered a hot gas filter where the char was separated from the pyrolysis vapors. The vapors were passed through two ethyleneglycol cooled condensers and electrostatic precipitator and a vapor filter before being released into the exhaust chamber.

The reactor, hot gas filter, condensers and electrostatic precipitators were all weighed before and after the reaction to determine the mass balance. The gases were analyzed online in an SRI gas chromatograph and some gas samples were collected in gas bags for later analysis to backup the initial data. The liquid products were sent to Galbraith Laboratories for elemental compositional analysis.

TABLE 3
Test matrix with and without biomass catalysts to demonstrate how these
catalysts influence pyrolysis efficiency and product distribution

| | | | Test | Oil | Char | Gas |
|---|---|---|---|---|---|---|
| | | | Temperature | Yield | Yield | Yield |
| Catalyst Code | State | Composition | (° C.) | (wt %) | (wt %) | (wt %) |
| Baseline Blank | | | 400 | 59.33 | 17.17 | 23.54 |
| | | | 600 | 35.84 | 14.34 | 49.82 |
| BGC-1 | Liquid | MMT | 400 | 42.22 | 17.03 | 40.75 |
| | | | 600 | 36.02 | 10.72 | 53.26 |
| BGC-2-2/BGC-1 | Liquid | BGC-2-2/MMT | 400 | 55.30 | 21.50 | 23.20 |
| | | | 600 | 41.60 | 7.76 | 50.64 |
| BGC-3-2 | Liquid | | 400 | 57.50 | 20.83 | 21.67 |
| | | | 600 | 51.39 | 7.90 | 40.72 |
| BGC-3-2/BGC-1 | Liquid/Liquid | BGC-3-2/MMT | 400 | 59.39 | 21.57 | 19.11 |
| | | | 600 | 50.60 | 7.11 | 42.29 |
| BGC-3-1/BGC-1 | Powder/Liquid | BGC-3-1/MMT | 400 | 46.80 | 28.70 | 24.50 |

BGC-1 = MMT at 1% Mn
All others at 4 wt %

TABLE 4
Test matrix with and without biomass catalysts to demonstrate how these
catalysts influence pyrolysis efficiency and lowered CO₂ levels in gaseous
product mix shown in the last column of Table 3.

| | | | Test | | | | | | | |
|---|---|---|---|---|---|---|---|---|---|---|
| | | | Temperature | | | | | | Other | |
| Catalyst Code | State | Composition | (° C.) | CO | CO₂ | CH₄ | C₂H₂ | C₂H₆ | gases | CO/CO₂ |
| Baseline Blank | | | 400 | 55.82 | 20.35 | 15.20 | N/A | 3.01 | 4.73 | 2.74 |
| | | | 600 | 46.28 | 27.04 | 16.06 | 2.50 | 1.01 | 7.40 | 1.71 |
| BGC-1 | Liquid | MMT | 400 | 51.95 | 23.76 | 15.46 | 2.85 | 0.77 | 5.21 | 2.19 |
| | | | 600 | 56.53 | 16.34 | 15.33 | 2.60 | 0.95 | 8.26 | 3.46 |
| BGC-2-2/BGC-1 | Liquid/Liquid | BGC-2-2/MMT | 400 | 46.40 | 35.60 | 8.56 | 0.75 | 1.50 | 7.19 | 1.30 |
| | | | 600 | 55.34 | 14.73 | 14.90 | 0.86 | 1.87 | 12.29 | 3.76 |
| BGC-3-2 | Liquid | | 400 | 44.25 | 35.84 | 8.89 | 0.62 | 0.73 | 9.67 | 1.23 |
| | | | 600 | 57.27 | 18.85 | 11.68 | 0.47 | 0.80 | 10.93 | 3.04 |
| BGC-3-2/BGC-1 | Liquid/Liquid | BGC-3-2/MMT | 400 | 41.77 | 41.83 | 6.47 | 0.90 | 1.00 | 7.94 | 1.00 |
| | | | 600 | 53.39 | 21.68 | 12.67 | 1.80 | 0.71 | 9.66 | 2.46 |
| BGC-3-1/BGC-1 | Powder | BGC-3-1/MMT | 400 | 42.76 | 43.79 | 5.09 | 0.28 | 0.26 | 7.82 | 0.98 |

BGC-1 = MMT at 1% Mn
All others at 4 wt %

The “baseline blank” results in Table 4 illustrate the norm with regard to CO₂ formation relationship with temperature, namely, as temperature increases, so do CO₂ levels. Indeed the ratio of CO/CO₂ for this non catalyzed pyrolysis of Hybrid Poplar biomass decreases from 2.74 at 400 ° C. to 1.71 at 600 ° C. With the catalyzed tests the ratios reverse significantly with temperature increase. For example, in the test catalyzed by BGC-1, the CO/CO₂ ratio increases from 2.19 at 400 ° C. to 3.46 at 600 ° C. These results are completely counter intuitive and represent an important environmental and commercial benefit of carrying out biomass pyrolysis according to the methods herein. One rationalization of the lowering of CO₂ with catalysts herein is that these systems promote the reverse Bourdouard reaction CO₂ +C 4-* CO. Evidence for this is the decreased char yields at 600 ° C. with these catalysts, as shown in Table 3. The equilibrium only favors CO production at temperatures above 900 ° C., and CO₂ formation as temperatures fall from this high level. Remarkably catalyst systems as disclosed herein force CO formation at temperatures as low as 600 ° C.

It appears that liquid biomass catalyst samples are easier to handle in conducting biomass pyrolysis than the corresponding biomass catalysts in powder form. In addition, with biomass catalysts in liquid form they may achieve higher bio oil yield. This could be rationalized because better mixing or wetting with biomass can be attained with the liquid biomass nanoalloy catalysts.

TABLE 5
Characteristics of a bio-oil made with BGC-3-2/BGC-1 catalysts

| Parameter | As received basis | Dried calculation basis |
|---|---|---|
| Calorific value | 10750 (24.94 MJ/kg) | 11070 (25.68 MJ/kg) |
| Karl Fischer water | 2.89 | |
| Ash | <0.09 | <0.09 |
| Carbon | 65.96 | 67.9 |
| Hydrogen | 7.11 | 6.9 |
| Oxygen | 26.36 | 24.6 |
| Nitrogen | 0.5 | 0.5 |
| Sulfur | <0.5 | <0.5 |
| Manganese | 7.40 | |
| Chlorine | 54 | 56 |

Referring to Table 5, the sample used to generate the analytical results was generated at 600° C. using the catalyst of BGC-3-2 at 4%/ BGC-1 at 1%. The results of “as received basis” means the analytical data obtained from the product produced by pyrolysis at 600° C. while the results of “dried calculation basis” means the results of recalculation of the analytical data assuming the sample is dried; i.e., 2.89% water has been removed from the sample.

Bio-oils from pyrolysis processes with catalysts disclosed herein are more stable at ambient conditions. The analyses shown in Table 5, especially the lowered oxygen content (from conventional content >40% to ˜25% herein) is similar to that of bio-oils made by conventional pyrolysis processes using ZSM-5 catalysts, and those bio-oils are known to be relatively stable. However the yields from ZSM-5 are much lower than from processes described herein. Another difference is the higher viscosity of bio-oils described herein as compared with ZSM-5.

The subject nanoalloy catalyst, dual catalyst and methods disclosed herein produce increased weight percent of syngas, including carbon monoxide, relative to gasification of a biomass that is not in accordance with the subject method. The increased syngas production even occurs at gasification temperatures below conventional temperatures. Carbon monoxide and H₂ production from biomass occurs in each sample but, by contacting an organometallic compound(s) and nanoalloy catalyst with a biomass before or during gasification of the biomass, the syngas produced thereby is well suited for further processing.

It is therefore believed that the use of the subject method provides significant and unexpected benefits for the gasification process of biomass. The subject method increases gas yields, and reduces solid and liquid yields. Oil yields may also be increased, in one example, if desired. Char production is reduced. The subject methods will produce a dramatic and highly desirable benefit for processes, devices and systems for the gasification of biomass.

Other embodiments of the present invention will be apparent to those skilled in the art from consideration of the specification. It is intended that the specification and Figures be considered as exemplary only, with a true scope and spirit of the invention being indicated by the following claims.

What is claimed is:

1. A biomass pyrolysis catalyst composition comprising:
support particles and metallic catalyst particles adhered to the surface of the support particles,
wherein the metallic catalyst particles comprise an alloy represented by the formula (Aa)ₙ (Bb)ₙ (Cc)ₙ each of A, B, and C is a metal, each of a, b and c represents compositional stoichiometry, n is an integer greater than or equal to zero and the sum of the n′s is greater than or equal to 2;
wherein the alloy comprises at least two different metals;
wherein the metallic catalyst comprises about 30% to 70% by weight of the composition; and
wherein the average particle size of the metallic catalyst particles is about 1 to 250 nanometers.

2. A biomass pyrolysis catalyst composition as described in claim 1, wherein the metallic catalyst comprises about 40% to 60% by weight of the composition.

3. A biomass pyrolysis catalyst composition as described in claim 1, wherein the metallic catalyst comprises about 45% to 55% by weight of the composition.

4. A biomass pyrolysis catalyst composition as described in claim 1, wherein the average particle size of the metallic catalyst particles is about 2 to 100 nanometers.

5. A biomass pyrolysis catalyst composition as described in claim 1, wherein the average particle size of the metallic catalyst particles is about 5 to 30 nanometers.

6. A biomass pyrolysis catalyst composition as described in claim 1, wherein the metallic catalyst particles are physically adsorbed to the surface of the support particles.

7. A biomass pyrolysis catalyst composition as described in claim 1, wherein the two or more metals A, B and C are selected from the group consisting of Mn, Fe, Cu, Co, Ca, Rh, Pd, Pt, Ru, Ir, Ag, Au, Ce, Mg, Al, Si, Sc, Ti, Zn, Si, Y, Zr, Mo, In, Sn, Ba, La, Hf, Ta, W, Re, Yb and Lu.

8. A biomass pyrolysis catalyst composition as described in claim 1, wherein the metal A is a primary catalyst selected from the group consisting of Ni, Fe, Ce, Co, Mo, Mn, Ca, Mg and La.

9. A biomass pyrolysis catalyst composition as described in claim 8, wherein metal B is a co-catalyst selected from the group consisting of Cu, Ce, Ni, Pt, Pd, Rh, Ru and Ir.

10. A biomass pyrolysis catalyst composition as described in claim 9, wherein metal C is an anti-sintering metal selected from the group consisting of Ce, K, Li, Zr, Hf, Mg and Ti.

11. A biomass pyrolysis catalyst composition as described in claim 1, wherein the support particles are comprised of a material selected from the group consisting of silica, alumina, magnesia, thoria, zirconia, nanotubes, nanoballs, graphene, zeolite and aerogel.

12. A biomass pyrolysis catalyst composition as described in claim 1, wherein the average particle size of the support particles is about 10 μm to 50 nanometers.

13. A method of reducing the amount of carbon dioxide formed during biomass pyrolysis comprising the steps of:
providing biomass material;
providing a catalyst composition comprising support particles and metallic catalyst particles adhered to the surface of the support particles,
wherein the metallic catalyst particles comprise an alloy represented by the formula (Aa)ₙ (Bb)ₙ (Cc)ₙ each of A, B and C is a metal, each of a, b and c represents compositional stoichiometry, n is an integer greater than or equal to zero and the sum of the n′s is greater than or equal to 2;
wherein the alloy comprises at least two different metals;
wherein the metallic catalyst comprises about 30 to 70% by weight of the composition; and
wherein the average particle size of the metallic catalyst particles is about 1 to 250 nanometers;
before or during a pyrolysis reaction, contacting the biomass material with the catalyst composition at a temperature up to about 800° C.;
whereby less carbon dioxide results from the pyrolysis reaction as compared with the same reaction without the presence of the catalyst composition.

14. A method of reducing the amount of carbon dioxide formed during biomass pyrolysis as claimed in claim 13, wherein the reaction temperature is up to about 600° C.

15. A method of reducing the amount of carbon dioxide formed during biomass pyrolysis as claimed in claim 13, wherein the reaction temperature is between about 400° to 600° C.

16. A method of reducing the amount of carbon dioxide formed during biomass pyrolysis as claimed in claim 13, wherein the catalyst composition is added to the reaction in the form of a powder.

17. A method of reducing the amount of carbon dioxide formed during biomass pyrolysis as claimed in claim 13, wherein the catalyst composition is added to the reaction in the form of a liquid with the catalyst composition dispersed therein.

18. A method of reducing the amount of char formed during biomass pyrolysis comprising the steps of:
providing biomass material;
providing a catalyst composition comprising support particles and metallic catalyst particles adhered to the surface of the support particles,
wherein the metallic catalyst particles comprise an alloy represented by the formula (Aa)ₙ (Bb)ₙ (Cc)ₙ each of A, B and C is a metal, each of a, b and c represents compositional stoichiometry, n is an integer greater than or equal to zero and the sum of the n′s is greater than or equal to 2;
wherein the alloy comprises at least two different metals;
wherein the metallic catalyst comprises about 30 to 70% by weight of the composition; and
wherein the average particle size of the metallic catalyst particles is about 1 to 250 nanometers;
before or during a pyrolysis reaction, contacting the biomass material with the catalyst composition at a temperature up to about 800° C.;
whereby less char results from the pyrolysis reaction as compared with the same reaction without the presence of the catalyst composition.

19. A method of forming a higher ratio of carbon monoxide to carbon dioxide during biomass pyrolysis, the method comprising the steps of:
providing biomass material;
providing a catalyst composition comprising support particles and metallic catalyst particles adhered to the surface of the support particles,
wherein the metallic catalyst particles comprise an alloy represented by the formula (Aa)ₙ (Bb)ₙ (Cc)ₙ each of A, B and C is a metal, each of a, b and c represents compositional stoichiometry, n is an integer greater than or equal to zero and the sum of the n′s is greater than or equal to 2;
wherein the alloy comprises at least two different metals;
wherein the metallic catalyst comprises about 30 to 70% by weight of the composition; and
wherein the average particle size of the metallic catalyst particles is about 1 to 250 nanometers;
before or during a pyrolysis reaction, contacting the biomass material with the catalyst composition at a temperature up to about 800° C.;
whereby the resulting ratio formation of carbon monoxide to carbon dioxide is higher as compared with the same pyrolysis reaction without the presence of the catalyst composition.
